(19) United States
(12) Patent Application Publication
(10) Pub. No.: US 2005/0116495 A1
(43) Pub. Date: Jun. 2, 2005

(54) Rear panel for a motor vehicle fitted with a convertible roof

(76) Inventors: Jean-Marc Guillez, Cirieres (FR); Paul Queveau, Montravers (FR); Gerard Queveau, Le Pin (FR)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 10/501,966

(22) PCT Filed: Dec. 11, 2002
(86) PCT No.: PCT/FR02/04289

(30) Foreign Application Priority Data
Jan. 21, 2002 (FR) 02/00699

(51) Int. Cl. B60J 7/20

(52) U.S. Cl. 296/136.05

(57) ABSTRACT

The invention relates to a rear panel for a vehicle fitted with a convertible roof which may be stored in the rear boot (2), guide means for displacing said panel from a first closed position, in which the above extends essentially horizontally between a chassis element (1) of the vehicle and the front edge of a lid (3) for said boot, into a raised position in which said lid is arranged essentially vertically such as to release a space for the passage of said roof between said chassis element (1) and said front edge. The panel is characterised in comprising a front longitudinal piece (4) and a rear longitudinal piece (5) and the guide means are arranged to place the front longitudinal pieces (4) and the rear longitudinal pieces (5) essentially parallel to each other in the raised position, with the front pieces in front of the rear pieces and to place said pieces (4, 5) in a second closed position where the panel is arranged essentially horizontally between the chassis (1) and the rear edge of the rear part (14) of the roof with the rear edge of the front longitudinal piece (4) overlapping the front edge of the rear longitudinal piece (5).

The present invention concerns a rear panel for a motor vehicle, and more particularly a motor vehicle provided with a roof which can be folded in the rear boot and guidance means able to make the said panel pass from a first closed position of use in which it extends substantially horizontally between an element of the vehicle chassis and the front edge of a lid of the said boot, and a retracted position in which it is disposed substantially vertically so as to leave clear a passage space for the said roof between the said chassis element and the said front edge.

Such vehicles are known provided with a roof which can be folded in their rear boot.

This roof can in particular be formed by a plurality of rigid roof parts able either to close off the vehicle cabin like a coupe or a saloon, or to be stored in the rear boot in order to make a cabriolet of it.

These vehicles are also provided with a rear panel joining the top part of the rear seat back rest to the front end of the boot lid.

Various proposals have already been formed in order to retract this panel into a vertical position when the roof passes from one position to another so as to release a passage for the roof elements.

The problem which is then posed is that of the height of the panel when it is in this position, as well as its longitudinal position.

This height must in fact not be too great so that the panel does not interfere with the roof. Moreover, the panel must be as far forward as possible in order to leave clear the maximum longitudinal space between it and the front edge of the boot lid for passage of the roof elements.

Another problem which is posed is that of the interposing of the rear edge of the rear part of the roof between the rear edge of the panel and the front edge of the boot lid when the roof is in its closed position in which it covers the vehicle cabin.

This is because, in this position, the thickness of the rear edge of the rear part of the roof occupies a certain longitudinal space so that it is necessary to retract part of the longitudinal bulk of the rear panel when the roof is in the closed position.

The present invention aims to provide a rear panel for resolving these problems.

To this end, one object of the invention is a rear panel for a motor vehicle provided with a roof which can be folded into the rear boot and guidance means able to make the said panel pass from a first closed position in which it extends substantially horizontally between an element of the vehicle chassis and the front edge of a lid of the said boot, and a retracted position in which it is disposed substantially vertically so as to leave clear a passage space for the said roof between the said chassis element and the said front edge, characterised by the fact that it comprises a longitudinally front part and a longitudinally rear part, and in that the guidance means are arranged so as to bring the said longitudinally front and longitudinally rear parts into a retracted position substantially parallel to each other, the front part being in front of the rear part, and to bring these said parts into a second closed position in which the panel is disposed substantially horizontally between the chassis and the rear edge of the rear part of the roof, the rear edge of the longitudinally front part overlapping with the front edge of the longitudinally rear part.

It will be understood that, the two parts being disposed longitudinally side by side in the vertical retracted position of the panel, the vertical bulk of the latter is reduced. It is also possible to move it forward in order to release a longitudinally maximum passage for the roof elements.

Moreover, because of the partial overlap of the panel parts in the second closed position, the total longitudinal bulk of the panel is reduced, thus providing sufficient space to house the rear edge of the rear part of the roof.

In a particular embodiment, the longitudinally front part of the panel is mounted for rotation about a transverse shaft integral with the vehicle chassis.

Also in a particular embodiment, the longitudinally rear part of the panel is articulated about two transverse shafts with first ends of two connecting rods, the other ends of which are each articulated on the vehicle chassis about a transverse shaft so as to form a deformable parallelogram.

Another object of the invention is a motor vehicle characterised by the fact that it comprises a rear panel as described above.

A description will now be given by way of non-limiting example of a particular embodiment of the invention with reference to the accompanying schematic drawings, in which:

FIG. 1 is a view in longitudinal section of the rear part of a vehicle according to the invention with the roof folded in the rear boot and the panel in the closed position;

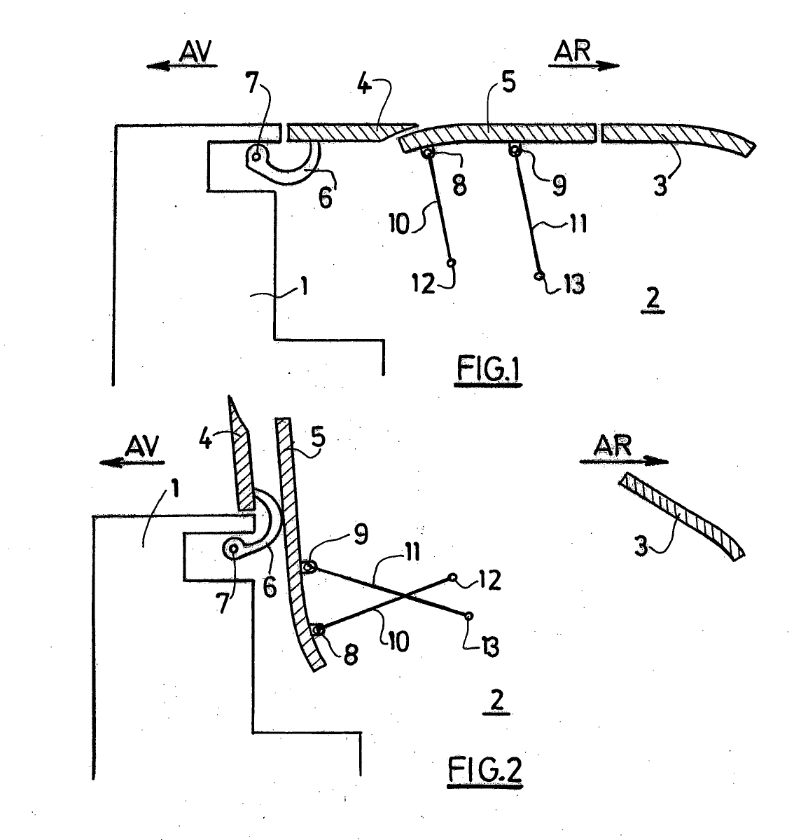

FIG. 2 is a view similar to FIG. 1 with the panel in the open position; and

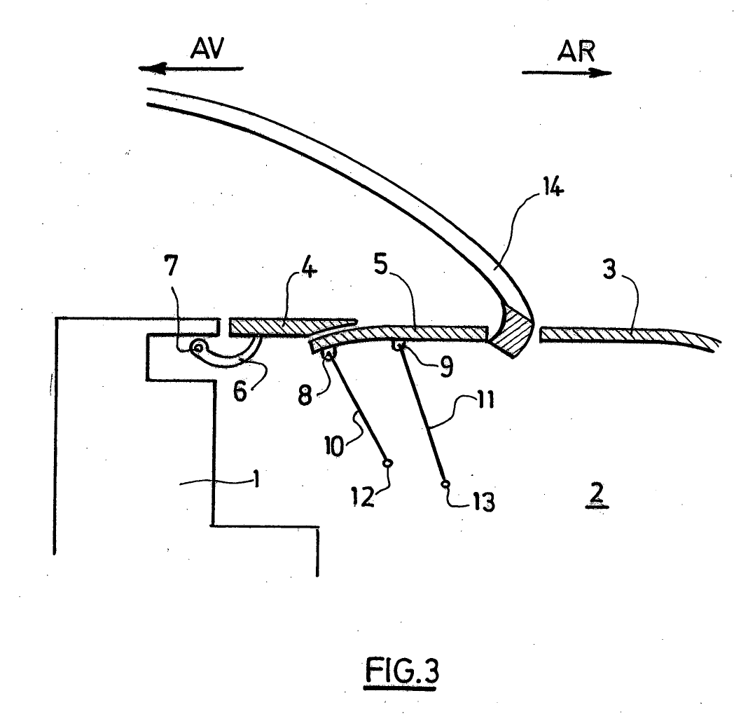

FIG. 3 is a view similar to FIGS. 1 and 2 with the roof in the position of closure of the vehicle cabin and the rear panel also in the closed position.

The vehicle depicted in the drawings comprises a chassis 1, a rear boot 2 closed by a lid 3 and a rear panel formed by a longitudinally front part 4 and a longitudinally rear part 5.

Longitudinally means in the direction from front (arrow AV) to rear (arrow AR) of the vehicle. The transverse direction is the direction perpendicular to the plane of the figures.

The rear panel is therefore divided transversely into two parts.

The rear edge of the front part 4 is here thinned and the front edge of the rear part is slightly curved downwards, so as to obtain a satisfactory connection of the two parts in the two closed positions of the panel. The overlap is however less in the position in FIG. 1 (roof open) than that in FIG. 3 (roof closed).

The front part 4 is mounted by means of a lever 6 with which it is integral, pivoting about a transverse shaft 7 fixed with respect to the chassis.

The rear part 5 is provided with a front cover 8 and a rear cover 9 on which there are articulated, about transverse shafts, the ends of two links 10 and 11 respectively.

The other ends of the links are articulated at 12 and 13 respectively about transverse shafts fixed with respect to the chassis.

Thus the part 5 is mounted on the chassis by means of a deformable parallelogram.

In the position in FIG. 1, the front edge of the part 4 of the panel is contiguous with the rear edge of the chassis 1 with a slight overlap, the front edge of the part 5 of the panel is contiguous with the rear edge of the part 4 of the panel, and the front edge of the lid 3 is contiguous with the rear edge of the part 5 of the panel.

The lever 6 and shaft 7 make it possible to make the part 4 of the panel pivot upwards as depicted in FIG. 2.

In this position, the part 4 is substantially vertical above the chassis.

Also in this figure, the deformable parallelogram formed of the links 10 and 11 has also brought the part 5 of the panel into a substantially vertical position, parallel to the part 4, the front edge of the part 5 overlapping the part 4.

In this position, the lid 3 has been tilted about its rear edge so that a passage space is available between the front edge of the lid 3 and the top edges of the parts 4 and 5 of the panel.

Finally, in FIG. 3, the rear edge of the rear part 14 of the roof has come to be disposed just in front of the front edge of the lid 3. The front part 4 of the panel has returned to its position in FIG. 1 and the rear part 5 of the panel has come into abutment against the rear edge of the part 14 of the roof, which is therefore interposed between the rear edge of the rear part 5 of the panel and the front edge of the lid 3.

The deformable parallelogram formed by the links 10 and 11 has however not returned exactly to the same position as that in FIG. 1, so that the rear edge of the front part 4 of the panel straddles the front edge of the rear part 5 of the panel over a longitudinal distance substantially equal to the thickness of the rear edge of the rear part 14 of the roof.

The arrangement which has just been described therefore makes it possible, through the straddling of the parts 4 and 5 of the panel, to gain in the longitudinal direction of the latter the thickness of the rear edge of the roof.

The panel can be manoeuvred by any known means, such as a motor or a cylinder, in order to bring it into its three positions in FIGS. 1 to 3.

1. A rear panel for a motor vehicle provided with a roof which can be folded into the rear boot (2) and guidance means able to make the said panel pass from a first position of use in which it extends substantially horizontally between an element of the vehicle chassis (1) and the front edge of a lid (3) of the said boot, and a retracted position in which it is disposed substantially vertically so as to leave clear a passage space for the said roof between the said chassis element (1) and the said front edge, characterised by the fact that it comprises a longitudinally front part (4) and a longitudinally rear part (5), and in that the guidance means are arranged so as to bring the said longitudinally front (4) and longitudinally rear (5) parts substantially parallel to each other, one of the said parts overlapping the other, and to bring these said parts (4, 5) into a second closed position in which the panel is disposed substantially horizontally between the chassis (1) and the rear edge of the rear part (14) of the roof, the rear edge of the longitudinally front part (4) overlapping with the front edge of the longitudinally rear part (5).

2. A panel according to claim 1, characterised by the fact that the longitudinally front part (4) of the said panel is mounted for rotation about a transverse shaft (7) integral with the chassis (1) of the vehicle.

3. A panel according to claim 1, characterised by the fact that the longitudinally rear part (5) of the panel is articulated about two transverse shafts at first ends of two links (10, 11), the other ends of which are each articulated on the chassis (1) of the vehicle about a transverse shaft so as to form a deformable parallelogram.

4. A motor vehicle, characterised by the fact that it comprises a rear panel according to claim 1.
